(19) United States
(12) Patent Application Publication
(10) Pub. No.: US 2018/0343184 A1
(43) Pub. Date: Nov. 29, 2018

(54) Platform for Multi-Function Network Resource Analysis

(71) Applicant: Ehrlich Wesen & Dauer, LLC., Pittsburgh, PA (US)

(72) Inventor: Jeremy A. Degroat, Panama City, FL (US)

(21) Appl. No.: 15/698,649

(22) Filed: Sep. 8, 2017

Related U.S. Application Data
(60) Provisional application No. 62/511,273, filed on May 25, 2017.

(51) Int. Cl. H04L 12/26; H04L 12/24

(52) U.S. Cl. CPC H04L 43/14; H04L 43/04; H04L 41/50; H04L 41/14; H04L 41/0853

(57) ABSTRACT

Exemplary embodiments for a Platform for Multi-Function Network Resource Analysis may comprise a distributed software platform for the development, delivery, and operation of applications, components, and modifications that perform network resource analysis and augmentation in a consistent, unified way on behalf of a variety of users and stakeholders via a range of interfaces.

### PRIORITY

This application claims priority to U.S. Provisional Application No. 62/511,273, filed May 25, 2017, titled “Platform for Multi-Function Network Resource Analysis”, which is incorporated by reference in its entirety herein.

### BACKGROUND

There are many different kinds of existing Internet crawling and analysis applications, including general Internet search engines, vulnerability scanners, web scrapers, performance testing tools, SEO evaluators, web archivers, and so on. Though each addresses a very different end-user problem, they implement a common technical pattern. Specifically, these applications remotely access a set of network resources, perform a computation on the set, and then make the results available in one or more forms to interested parties.

Often, a crawler-based application offers only part of an overall solution, and so the customer must purchase and employ several different products to achieve a higher-order objective. For example, a website owner may acquire performance testing tools, usability analyzers, availability monitors, SEO evaluation services, and three different vulnerability scanners to address the actual goal of publishing useful and profitable web services.

Even though each of these tools follows the pattern identified above, they are rarely, if ever, designed to work together. The customer must run each tool separately, consuming redundant processing, network, and storage resources, both locally and remotely. Further, the results must be integrated manually to provide a complete picture of progress towards the actual goal.

An issue for more sophisticated customers is that they are limited by the specific functionality provided by the tool. If an unanticipated test or analysis is required, yet another tool must be purchased or separately employed. If there is no existing product that performs the desired function, the organization is faced with a decision to build a complete crawler stack from scratch or go without.

Traditional approaches to network resource analysis and augmentation exhibit topic-centricity, meaning that a particular technology is chosen, adopted, and executed to address a particular concern, such as “security” or “performance”, and then the particular targets for that technology are chosen, such as a website, or internal web application, or Internet service. This results in possibly several different tools being used to address many separate concerns over the same asset base. Because each tool creates its own model of the targets being analyzed, there is no easy way to integrate the results.

### SUMMARY

Exemplary embodiments for a Platform for Multi-Function Network Resource Analysis may comprise a distributed software platform for the development, delivery, and operation of applications, components, and modifications that perform network resource analysis and augmentation in a consistent, unified way on behalf of a variety of users and stakeholders via a range of interfaces.

### DRAWINGS

FIG. 1 illustrates an exemplary Modular Platform for Multi-Function Network Resource Analysis.

FIG. 2 illustrates an exemplary Distributed Platform for Multi-Function Network Resource Analysis.

FIG. 3 illustrates an exemplary stored index including a plurality of exemplary resource scope keys.

FIG. 4 illustrates an exemplary platform according to embodiments described herein.

FIG. 5 illustrates an exemplary embodiment of a Modular Platform architecture in which processes are split into well-defined categories of services and jobs.

FIG. 6 illustrates an exemplary Common Messaging Protocol according to embodiments described herein.

FIG. 7 illustrates an exemplary portion of a user interface scheme according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments of the Platform for Multi-Function Network Resource Analysis described herein may provide a unified set of user interfaces, processing functions, data storage options, and extension points to enable any kind of network resource analysis from a single system platform. Users may define their web or network assets, and the functions to run against them. Any kind of a disparate variety of network resources may be targeted. Several properties may be examined, including, without limitation: security, privacy, content integrity, encryption, availability, performance, and usability, as well as many others. Data from third-party web and network resources may be crawled, filtered, mined, and organized. In an exemplary embodiment, all data is indexed by network resource, allowing a user to easily navigate and cross-reference various characteristics of analyzed targets.

In an exemplary embodiment, the Platform for Multi-Function Network Resource Analysis may be a module platform that can be distributed across different devices. With the right combination of modules, a user could use the system for web application security scanning, web performance auditing, SEO testing, Internet search, social media data mining, market research, other network resource analysis, and combinations thereof. The user may be provided a template of modules for given tasks or objectives or the user may select or modify modules to achieve their desired goals. The same system could be used for all of the above. Hybrid uses previously unimaginable are also possible. Exemplary embodiments may therefore permit dynamic selection or building of network resource analytics tools without requiring a design from the ground up.

Although embodiments of the invention may be described and illustrated herein in terms of specific applications of exemplary building blocks, it should be understood that embodiments of this invention are not so limited, but are additionally applicable to any combination of features or components described herein.

Instead of adopting and manually integrating a series of point-solutions to partial problems, exemplary embodiments of the Platform for Multi-Function Network Resource Analysis propose the unified management of network resource analysis tasks with a common software platform to achieve higher-order goals. In an exemplary embodiment, network resources are managed as assets, individually or in combination with each other, whether controlled by the user or published by a third-party, and the various functions and analyses are performed in concert. Instead of answering separate questions about security, performance, usability, privacy, availability, integrity, and so on, exemplary embodiments of the Platform for Multi-Function Network Resource Analysis takes a resource-centric view and provide a basis for combining information concerning the various properties of targeted resources.

Exemplary embodiments of the Platform for Multi-Function Network Resource Analysis encourage, and can be optimized for, an asset-centric approach to network resource and augmentation. Rather than attempt to identify and specify a particular concern in advance, application users may declare the particular targets of interest, and then progressively adopt analysis modules as needed. As jobs are run against these targets and services engaged to receive data, all data can be keyed to a particular resource scope allowing quick and easy cross-referencing. This permits end-users to ask higher level questions about the assets they own, compete with, or use. It also allows them to evolve a fully-integrated knowledge base about these assets over time.

Exemplary embodiments may be implemented as a distributed software platform for the development, delivery, and operation of applications, components, and modifications that perform network resource analysis and augmentation in a consistent, unified way on behalf of a variety of users and stakeholders via a range of interfaces. The platform itself may be used by developers and operators to build, distribute, and host services for end-users.

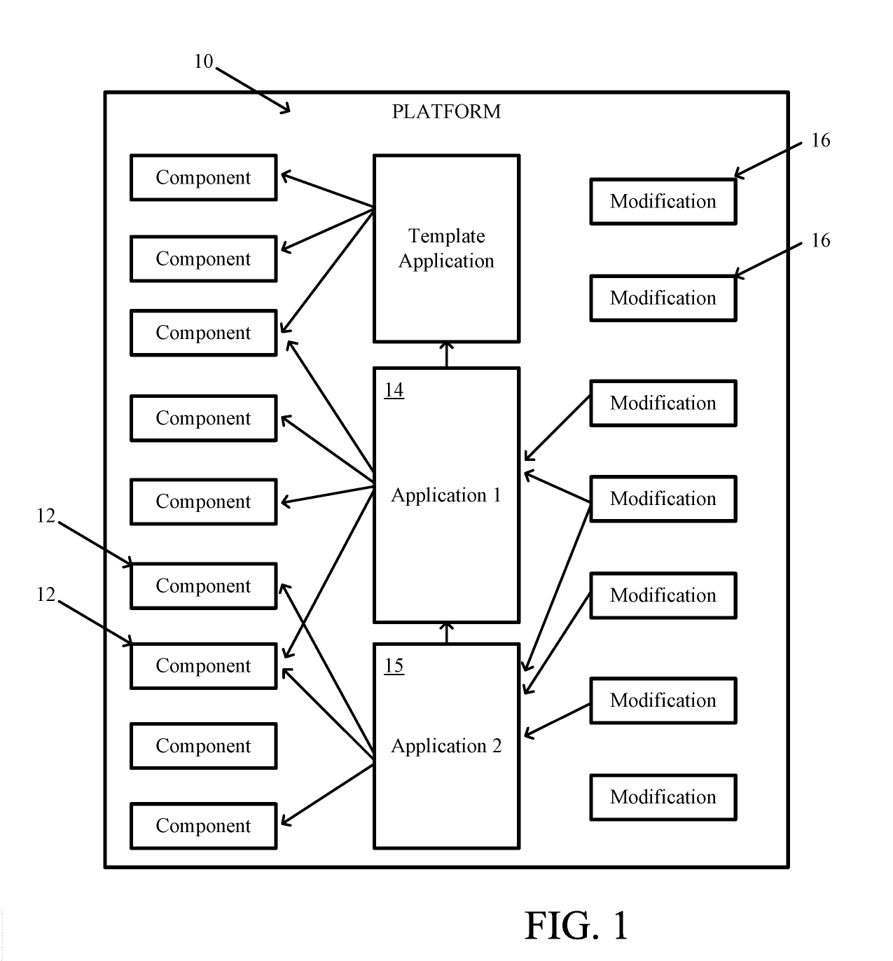

FIG. 1 illustrates an exemplary Modular Platform for Multi-Function Network Resource Analysis. The Modular Platform 10 can be considered as separate implementation units that can be acquired through the distribution network and, in turn, linked to other implementation units in a variety of ways. Exemplary Modular Platform for Multi-Function Network Resource Analysis implementation units may include components 12, applications 14, 15, and modifications 16.

Exemplary components 12 may implement the basic units of work performed by the system. All services, jobs, data access methods, and storage mechanisms can be backed by one or more components. These components are inserted between clean, well-defined interfaces, making integration trivial and allowing alternatives to be easily swapped in and out.

Exemplary categories of components may include acquisition, transformation, publication, and expiration. Acquisition jobs and services are the input functions of the system. These include modules that probe, scan, crawl, listen, proxy, report (via agents), monitor uploads, integrate with other products, and handle supplemental user data. Transformation jobs and services are the data processing methods that take the raw data acquired and convert it into useful and presentable tables of information. These include aggregators, filters, joins, pattern matchers, normalizers, calculators, counters, scorers, and others. Publication jobs and services make the project data accessible in various forms. Many of these forms are available through the Visualization functions of the user interface. Other outputs include email notifications, data services, file exports, rule and pattern uploads (to firewalls, for example), and integrations with other products. Expiration jobs and services are responsible for deleting data from the system to make room for new data, based on rules specified by the user and the module defaults.

Exemplary applications 14, 15 may be the top-level structure that end-users access in order to perform the desired work. An application can be acquired through the distribution network by a service provider and made available to end-users via the web or other means. The applications can include a mapping of services, jobs, data access methods, and storage mechanisms to platform components, as well as optional files (HTML, CSS, JavaScript) containing code to support web application user interfaces. An application may be entirely independent, or it may inherit configuration and files from a parent application, which it then supplements with additional functionality.

Exemplary modification 16 may include a patch against an application that modifies the component mapping, or optional code files, or both, in order to change the behavior or appearance of the application. A modification may be as simple as one that corrects typos that the original developer neglected to fix, or as complex as a complete rewrite that changes the web user interface's navigation flow, graphics, color scheme, and language. A modification may provide third-parties a way to implement and distribute user interface themes, interface simplifications, language translations, and other kinds of conversions. Modifications can be distributed through an integrated marketplace, along with the components and applications.

The platform also includes data. Project data can exist in exemplary four groups: Control Data, Status Data, Subject Data, and Backup(s). Control Data includes configuration and command information that jobs and services use to coordinate their activities. Status Data includes feedback and logs from the jobs and services that the user can monitor. Subject Data is all the raw and/or processed data concerning the network resources being explored and analyzed. Data may be indexed by module ownership and network resource location/state. Backups are offsite replications of all the other project data. Backups can be used to fully restore a cluster if data loss occurs.

Subject Data may be keyed to a particular resource scope allowing quick and easy cross-referencing. Each module writes its data to a store or database, indexed by the network resource identifier. This allows for easy cross-referencing and correlation between modules. The network resource identifier may be a set of optional scope parameters. In an exemplary embodiment, parameters that are blank are ignored, and parameters that contain wildcards specify a range of possible resource matches. Summary data across multiple resources may be indexed by using the common parameters and wildcards/patterns may be used for parameters that differ. Each record may be owned by a module. In an exemplary embodiment, only the module owning a record and authorized users may be able to write to the record. Read permissions could be granted to other modules and other users.

In an exemplary embodiment, subject data may comprise multiple keys. For example, the subject data may include a project identifier, namespace identifier, resource identifier, property name, and combinations thereof. The project identifier may map to an accounting containing the subset of data particular to the project. The resource identifier may include a plurality of different resource scopes to permit variable cross-reference and correlation between module of different levels of resource analysis. The name space identifier maps components available for the project. The name space identifier may determine which component, device, or user, has permissions to write data. The name space identifier may also define the data model or the kind or type of data to be recorded, i.e. the table definition.

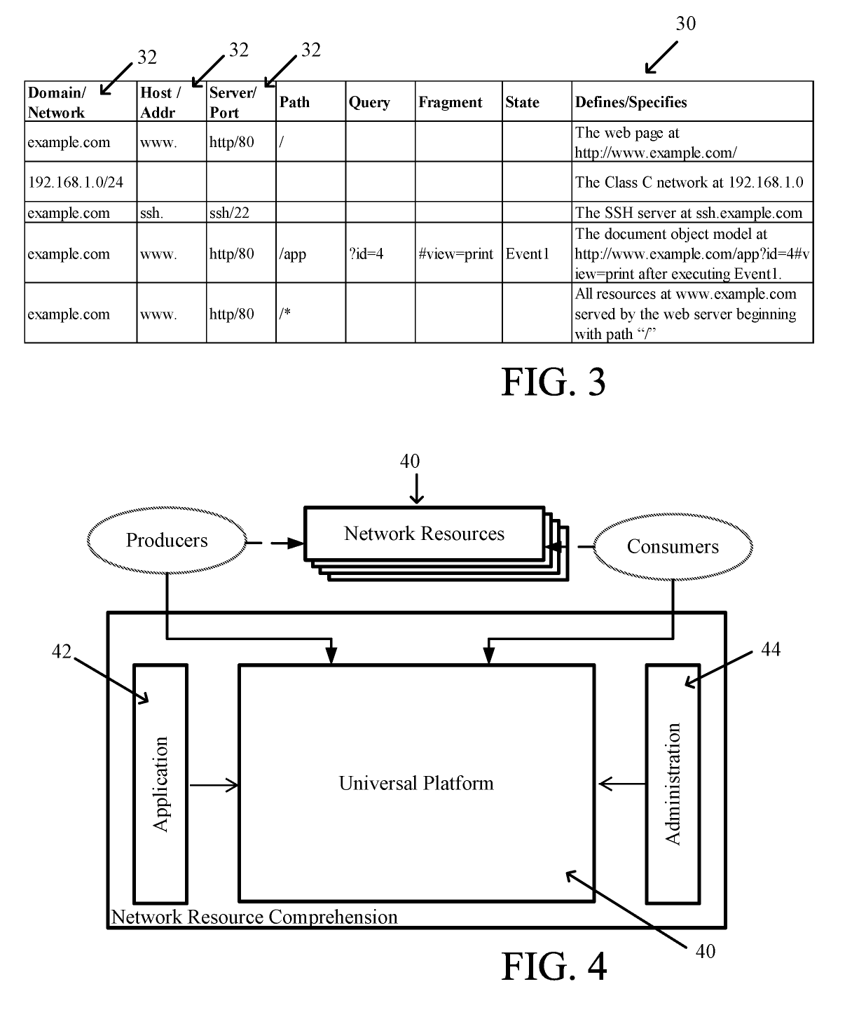

In an exemplary embodiment the resource identifier includes a plurality of resource scope keys. FIG. 3 illustrates an exemplary stored index 30 including a plurality of resource scope keys 32. The resource scope key 32 may include an identifier for various levels or hierarchy of resource identification. The plurality of resource scope keys may include the domain name, host address, server, path, query, fragment, state, and combinations thereof. The plurality of resource keys may therefore identify and distinguish different resources. For example, the resource may be a website, network, server, document object, or other element available on a network. The hierarchy of resource related identifiers permits the different elements to be identified and distinguished at different levels of specificity as commiserate with the resource. The plurality of scope keys related to the resource permit different patterns to be matched against the subject data and relate data from different modules for use across modules and analytical functions and processes.

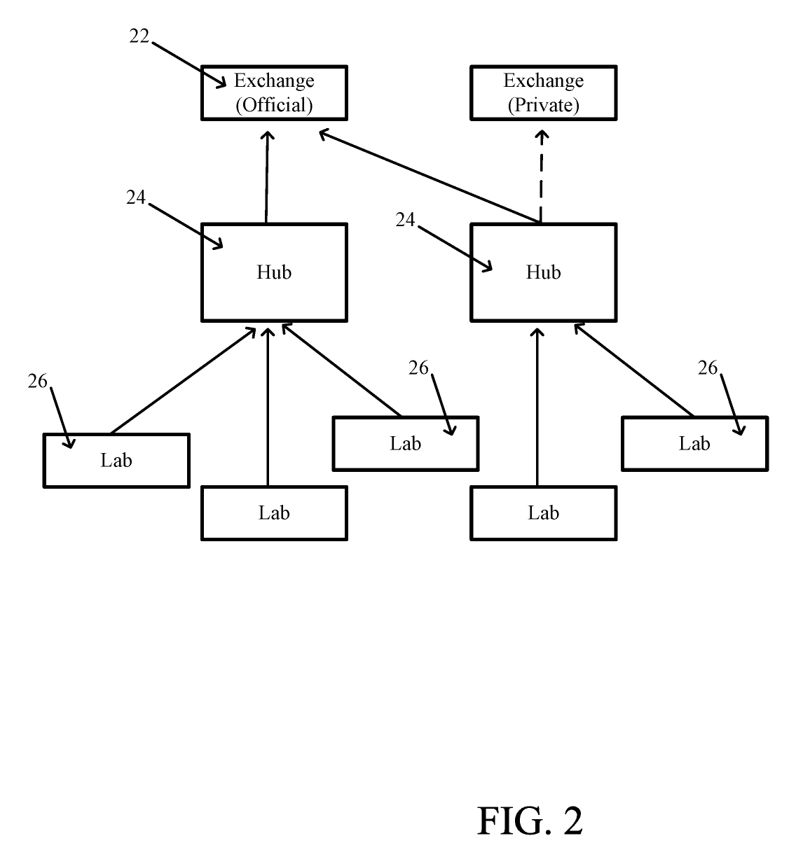

FIG. 2 illustrates an exemplary Distributed Platform for Multi-Function Network Resource Analysis. Exemplary embodiments may comprise a set of templates, libraries, tools, and server processes that are installed to a set of machines and operated by a service provider. The service provider links its installation to one or more exchanges and deploys applications as desired. End-users then access and use the applications hosted by the installation.

An exemplary Exchange 22 may include a central repository where applications, components, and modifications may be stored for download and/or sale by consumers.

An exemplary Hub 24 may include an installation that manages user accounts, mediates financial transactions, and coordinates projects. Exemplary hubs may be operated by a cloud service provider or private organization for internal use.

An exemplary Lab 26 includes a distributed system or network of computers or devices that receive components from the Hub and performs analysis jobs and services within the projects assigned to it. One or more labs may be controlled by a Hub, and each Hub may receive its packages, modules, and updates from an Exchange.

In an exemplary embodiment, the exchange may store and provide access to different components, applications, and modifications. In an exemplary embodiment, the exchange is a storehouse of all modules of the platform software for download, distribution, and/or installation at remote systems. The exchange then communicates over a network to a plurality of hubs. One or more hubs may be operated by a service provider or private network. The service provider may design different resource analysis tools by downloading and implementing a subset of modules (including components, applications, and/or modifications) from the exchange. The hub communicates and operates one or more labs. The different labs, under the control of the service provider, may be used to store, execute, communicate, or otherwise operate one or more modules, or portions thereof. For example, a lab may be a computer or server with processor and memory. The lab may then store and execute code stored as non-transitory computer readable media to perform functions described herein. The hub(s) and lab(s) may be the same or separate machines.

FIG. 4 illustrates an exemplary platform according to embodiments described herein. Exemplary embodiments comprise a platform for performing functions of exploring, analyzing, and augmenting network resources. Exemplary embodiments of the platform 40 contain and execute the basic components needed to facilitate any one or more resource comprehension use case(s). Exemplary embodiments of the platform components are configured to handle communications regardless of the initiator. Exemplary basic components may include software libraries, tools, templates, and server processes, as well as methods for extending and modifying these component parts. Exemplary embodiments may include use-case and audience-specific features and views as applications using the components of the platform. For example, the application may comprise component specification(s), default configuration, and any customized views to collect input from, or display results to, the user.

In an exemplary embodiment, if alternative or additional functions are called upon by an application, the functions may be implemented as standard components and included in the component specification for automatic download and integration.

In an exemplary embodiment, the system may include a uniquely defined application. Administration 44 may include a set of functions and interfaces for installing, authorizing, and managing the various applications, components, and users of the system. Exemplary embodiments may segregate functions that are available to the Administration that are not available to other applications or end users.

An exemplary embodiment of a Modular Platform for Multi-Function Network Resource Analysis comprises a plurality of modules that may be used to support different resource comprehension use-cases. Different architectural constructions may be used to enable the platform to support these different use-cases. For example, project processes may be split into well-defined categories of services and jobs, network and data services may be provided to projects in a standard and scalable manner, administrators may be allowed to extend and re-configure the system at runtime through the inclusion of applications and modules from remote sources, administrators and/or users may be permitted to override default application configurations with options that customize project processes, processes and data may be compartmentalized into projects in order to support multi-tenancy, security modes, and managing multiple sets of network resources, a common messaging protocol may be defined for internal requests and responses that make it possible to pipeline services as well as display and interact with data in a cross-functional manner, a user interface paradigm that uses a series of standardized headers to navigate through the various layers of system, operator, account, repository, project, and resource context, and any combination thereof.

In an exemplary embodiment, in order to perform a particular network resource comprehension use-case, the application may arrange and configure various services and jobs within a project container. A service may be seen as a process that waits for external initiation by a user or other process and performs some function for the initiator. A pipeline of services may be dynamically constructed (as specified by the project configuration) to handle requests and return responses. A job may be seen as a transient process that is started by a scheduler or triggered by an event and also performs a designated function. The project configuration defines the type of job, components used, and conditions for starting and stopping respective jobs. The combination of services and jobs within a project forms a kind of dynamic sub-architecture that is specific to the application, user, and set of network resources.

In an exemplary embodiment, each service or job type may be used to specify a set of required module types or interfaces, while the service or job instance may specify a mapping of module implementations to module types. Modules may be seen as software units that implement certain processing, delegation, or communication functions. By arranging and configuring the services and jobs in certain ways, any network resource comprehension use-case can be realized.

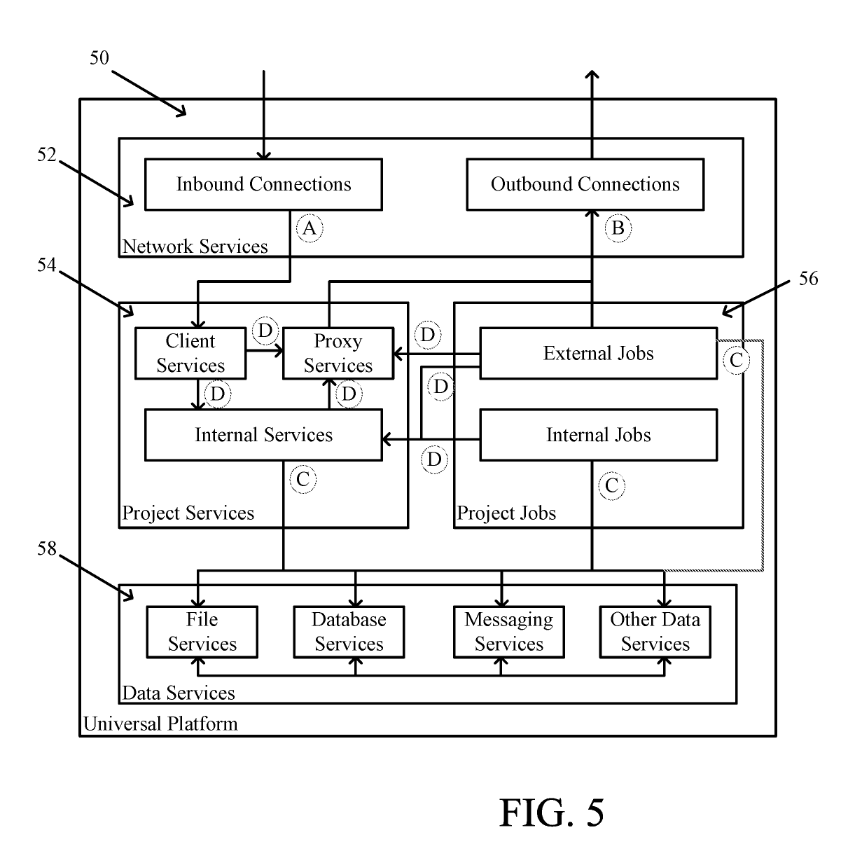

FIG. 5 illustrates an exemplary embodiment of a Modular Platform architecture in which processes are split into well-defined categories of services and jobs. FIG. 5 represents an exemplary decomposition of platform processes. The Module Platform may define categories such as network services 52, project services 54, project jobs 56, and data services 58.

Project services 54 and project jobs 56 may be configured to execute the resource-oriented acquisition, transformation, and publication tasks, in a variety of ways. In an exemplary embodiment, the project services and jobs may be divided into categories. As shown in FIG. 5, they can be divided into five categories: client services, proxy services, internal services, external jobs, and internal jobs.

In an exemplary embodiment, client services handle incoming requests concerning the network resources. These requests will often be in a protocol suitable for remote communications, such as HTTP (REST-based or other), FTP, SFTP, or any other network protocol. The format, likewise, may be one appropriate for computer exchange, such as HTML, XML, JSON, binary serialization (such as Java serialization, Google Protocol Buffers, Apache Thrift, Apache Avro, etc.) or any other format. Client services may convert from these external protocols and formats to an internal messaging protocol, which may or may not follow the Common Messaging Protocol, described herein. In crawler-based use-cases, client services may only be used by the operator to configure and control the processes and by the end-user to search and access results. For proxy-based use-cases, client services may convert requests to an internal format then hand off to services that eventually terminate at a proxy service, which returns a response.

In an exemplary embodiment, proxy services handle outgoing requests and responses concerning network resources. The opposite of client services, proxy services may convert internal messaging protocols into external protocols and formats that remote systems can recognize. Proxy services may be used by crawler-based processes to distribute, throttle, or mask traffic. Proxy services may also be used in handling proxy-based use-cases, where the system accepts requests from outside via client services and passes them on (eventually) to proxy services for conversion back into an external protocol or format.

In an exemplary embodiment, internal services filter, transform, or distribute internal messages for a variety of purposes. Client services, external jobs, internal jobs, and other internal services may pass messages to an internal service for further processing. Thus, internal services may be pipelined together in various ways by the application configuration to perform arbitrary processing tasks, such as filtering unwanted data, extracting network resource facts from data, and distributing the data to various internal destinations.

In an exemplary embodiment, external jobs are platform-initiated processes that explore, analyze, or otherwise interact with remote network resources. Like client services they may convert between Internet protocols (such as HTTP, FTP, SFTP, IRC, SSH, etc.), standards formats (such as HTML, XML, JSON, binary serialization), and internal messages. Also like client services, external jobs may be used for acquisition or publication or both, though they may perform in-line transformation as well. An exemplary difference is that external jobs may initiate the exchanges, whereas client services wait for remote initiation. When used for acquisition, external jobs may generate requests, pass them along to remote network resources (either directly or via proxy services), process the responses, and send any resulting messages to internal or data services. Examples include probing, downloading, scanning, crawling, querying, and scraping. When used for publication, external jobs may query internal or data services, convert internal messages into appropriate external formats, and submit them to remote network resources. Examples include uploading files or definitions to remote systems or utilizing a remote web service API to deliver commands or results. External jobs may be executed by a scheduler or triggered by an internal service, based on application configuration, operator commands, or incoming events.

In an exemplary embodiment, internal jobs may be platform-initiated processes that work with internal and data services to transform data about network resources. These jobs may provide a way to schedule or trigger conversions or merges of data stored in separate formats or tables by data services. They can be used to move data from persistent to volatile storage (such as RAM) or to create materialized views, which facilitate optimized data access for scalable services.

As seen in FIG. 5, the Modular Platform architecture, in which processes are split into well-defined categories of services and jobs, may also include network services 52. In an exemplary embodiment, network services may provide a set of services for inbound and outbound connections. Network services therefore provide access to and from the platform to and from the internet and other networks. As illustrated, the inbound and outbound connections may be separated.

In an exemplary embodiment, inbound connection services may intercept incoming connections and requests, and forward them along to the appropriate client services, as shown by the label A in FIG. 5. This layer may provide a place for system-wide load balancing, proxying between end-points to conceal datacenter locations, monitoring, logging, blacklisting, and caching.

In an exemplary embodiment, outbound connection services are used by proxy services and external jobs to access network resources on the Internet or other networks, as shown by Label B in FIG. 5. Similar to inbound connection services, these services may provide a place for system-wide load balancing, proxying between end-points to conceal datacenter locations, monitoring, logging, and throttling, among other functions.

As seen in FIG. 5, the Modular Platform architecture, in which processes are split into well-defined categories of services and jobs, may also include data services 58. In an exemplary embodiment, data services may permit project services and jobs to read, write, and exchange data. Exemplary embodiments of data services include customizable forms, including file services, database services, messaging services, and various other data services. Data services may be accessed (label C on FIG. 5) using a Common Messaging Protocol that enables cross-module integration.

In an exemplary embodiment, file services provide project services and jobs with basic file creation, retrieval, appending, and deletion functions, on top of a distributed filesystem, such as Hadoop DFS. Files may be stored in a folder-based hierarchy that separates by project, by module, by time, by resource scope, and/or by other configurable parameters. This is appropriate for services and jobs that need to store and process large amounts of raw, contiguous data in batch or high-latency modes.

In an exemplary embodiment, database services may offer projects access to an array of data storage and retrieval technologies, ranging from traditional, relational databases to key-value stores, document stores, and graph databases. As with other data services, they may be provided using a common messaging protocol. Database services can range greatly in terms of latency, throughput, and pre- and post-processing complexity, and thus offer the application and module developers the ability to make architectural tradeoffs appropriate to the use-case and audience.

In an exemplary embodiment, messaging services may offer project services and jobs a robust method of communication that ensures delivery of messages from sender to recipient, even when the communicating parties are not operating at the same time. The application and module developers can select between several messaging paradigms and integration patterns. However, as with other data services, users of messaging services may use the common messaging protocol.

In an exemplary embodiment, there may be other potential kinds of data services, including those that use volatile memory as a storage backend or that read and write to Internet-based object repositories. By developing additional modules and integrating them with core service types, the platform can be extended to manage data using any available medium.

Exemplary embodiments include a system configuration in which a wide range of use cases are available in network resource comprehension. Exemplary embodiments may be configured to download and make available to projects, operators, and end-users a variety of applications, project modules, network modules, and data modules from official or third party repositories.

An exemplary installation may host any number of projects with their own, independent configurations as specified by the application, system administrator, and application operator. In an exemplary embodiment, all projects may depend on system-wide services for networking and data management.

Exemplary embodiments described herein define a Common Messaging Protocol (CMP) for data storage and retrieval that is used for access to data services, and optional for interacting with project services. The CMP may provide a simple, but powerful, request and response framework that makes building and integrating services, jobs, and modules straight-forward. The protocol may be implemented using HTTP REST, XML RPC, existing binary serialization libraries, or custom data exchange formats.

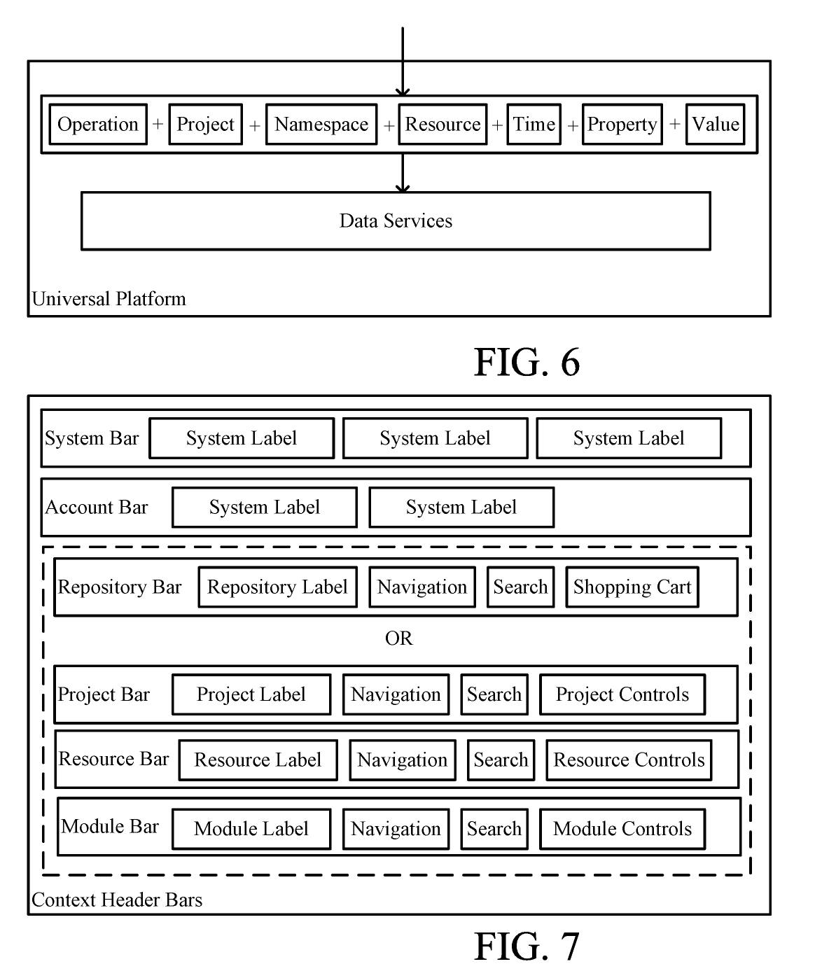

FIG. 6 illustrates an exemplary CMP according to embodiments described herein. Requests and responses described herein may have a common format. As shown in FIG. 6, each may contain one or more records each possessing some combination of the following fields: operation, project, namespace, resource, time, property, value. The operation field may specify either the action to take (in the case of requests) or the status of the operation (in the case of responses). The project field may define the hosted project to which this record corresponds. The namespace field may specify the developer, module and module-specific classifier for the record. The resource field may use a URL-like classification scheme to identify specific network resources or sets of resources. The time field may specify either an instant, duration, or range of time for which the record applies. The property field may define the attribute of the network resource in question. The value field may specify a value for the property of the network resource.

In an exemplary embodiment, the namespace and resource fields may be used as lookup keys which allow services and jobs to query and relay subject data based on topic (by namespace) or network object (by resource) or both. This may provide flexibility to examine objects with respect to a particular concern, or all concerns for a particular object, thus supporting integration and navigation.

Many of these fields may be omitted for each record, to imply generality or universality. Likewise, wildcards or lists of partial matches may be used to indicate an expanded scope. Records may be combined by enumerating multiple sets of certain fields for efficiency purposes (such as attaching a set of property and value fields to a single record containing operation, project, namespace, resource, and time fields that are common for the properties and values specified).

By clearly defining a small number of general fields and permitting each to specify an exact or partial match, any kind of messaging operation concerning network resources can be expressed.

Messages using the Common Messaging Protocol may be transmitted and encoded in a variety of ways, including TCP or UDP, HTTP or a custom application scheme, binary or text, XML or JSON. For the purposes of an exemplary embodiment, the Simplified Common Messaging Protocol (SCMP) will use TCP, a raw, line-oriented request-response protocol, and simple text representations. A client or server indicates it is done sending records by sending a blank line.

In this example, requests and responses are formatted using a series of records, each with an identical, sequential pattern of fields. These are: operation, project, namespace, resource, time, property, and value. For the purpose of the SCMP example, they will be delimited by spaces. The Project, Namespace, Resource, and Time fields form a unique key to a record. Various wildcarding schemes on these fields permit the arbitrary aggregation of records, providing a way to integrate subject data across project, namespace, resource, and time.

In the example embodiment, the operation field is included. In the case of request records, the Operation field specifies the command to pass along to the service. For the SCMP example, this consists of exactly two operations: PUT and GET. PUT instructs the service to store (or forward) this information in (or to) the appropriate location. Likewise, GET asks the service to read (or obtain from another service) one or more records matching the request record. For response records, the Operation field may be used to indicate some kind of status or quality information for the record returned. For the SCMP example, this field will be left blank.

In the example embodiment, the project field is included. The Project field specifies the project to which the request or response record pertains. For the SCMP example, it is simply an integer representing the project ID.

In the example embodiment, the namespace field is included. The Namespace field specifies the type of the record and provides a way for modules to designate the origin, purpose, and form of data being stored and retrieved. For the SCMP example, the Namespace field will appear as: developer.module.type[.subtype]. Prefacing (and enforcing) namespaces with developer and module names enables third-party modules to coexist in the same system without interfering with each other's operation. One possible scheme requires that only the developer and module named in the preface is permitted to PUT records, while other modules are (optionally) allowed to GET them.

In the example embodiment, the resource field is included. The Resource field specifies what network resource (or scope of network resources) is the subject of the data being manipulated. For the SCMP example, the Resource field consists of a set of optional scope parameters, many of which make up part of the standard URL syntax for a network resource. These include: domain/network, host/address, server/port, path, query (for HTTP-like resources), fragment (also for HTTP-like resources), and state. For GET operations, wildcards may be used to specify a scope of resources, rather than one specific target. Some examples are shown below. For the SCMP example, the Resource field contains all seven parts identified in FIG. 3 in the order defined therein, delimited by a pipe (|) character. If a part is not specified, it will be left blank.

In the example embodiment, the time field is included. The Time field is a flexible classifier for specifying an exact time or a range of times. When storing subject data using a PUT operation, the record will contain an exact time representing when the data was collected or “in effect”. When querying the subject data, the Time field may take a number of forms including an exact timestamp match, a range of times, a “before” or “since” notation, or a “within the last X time units” notation.

In the exemplary embodiment, the property field is included. The Property field specifies a variable name attached to the object in question. This can be anything, such as “name”, “age”, “price”, “size”, etc. It specifies “what” is being recorded or requested concerning the network resource. Wildcards may be used in GET operations.

In the exemplary embodiment, the value field is included. The Value field contains the actual data for the labeled property of the given network resource object identified by project, namespace, resource, and time. Like the Property field, it may contain anything, such as numbers, text, HTML, XML, images, PDFs, etc. For GET operations, wildcards may be used for pattern matching on the data.

In the exemplary embodiment, there are two basic operations for the SCMP example: PUT (injecting data) and GET (retrieving data). As subject data is collected and processed, new records are created by service processes and job processes and passed along to dependent services for processing, storage, or forwarding to other services. The SCMP provides the PUT operation for this purpose. In order to retrieve subject data for presentation or export, service processes and job processes construct records that define a scope of data to obtain and pass them along to dependent processes that may have the information needed. Unlike the PUT operation, wildcards may be used to match related records, rather than retrieve exact matches. For the SCMP example provided herein, a simple asterisk-based matching may be used where “the*” matches “the”, “them”, “theory”, “the$@#”, etc.

By design, the Simplified Common Messaging Protocol is a basic example of the core, unified data exchange method used by the platform. There may be many possible extensions to this protocol such as additional operations, parameterization of operations, property hierarchies, transactions, authorization tokens, and various optimizations. Additional operations are possible that use the same message format. UPD (update data) and DEL (delete data) operations could be implemented that revise an existing record or remove an existing record, respectively. Other operations could be devised and implemented as well in order to improve efficiency. However, additional operations may increase the complexity and increase the maintenance burdens. Operations could be parameterized to implement more specific behavior. As an example, the GET operation could be parameterized by a limit attribute (i.e. GET(LIMIT=5)) to return only the first X records that match the request. As another example, the PUT operation could be parameterized by a conditional (i.e. PUT(!EXISTS(TIME>20170415))) that must be true in order for the record to be stored or forwarded. These may increase throughput or make module code “cleaner”, but may increase the cost of implementation and maintenance. Property names may be annotated with a hierarchy to indicate a core data type, such as one of: representation, relation, property (normal), and composite. A simple way to implement this would be to label all properties using the pattern: type:name. Then, it becomes simple to query for all links (relations) from the network resource of interest, regardless of module or scope. A transactional wrapper could be implemented around a set of records to indicate that either all operations should succeed or none should. Authorization tokens could be added to the protocol to ensure that each operation is being ultimately initiated by a user with permissions to access the data stores in question. It is possible to optimize the protocol further at the cost of some human readability. An example would be to allow a set of one or more property and value pairs to be concatenated together in the Property and Value fields respectively, to avoid repeating common Operation, Project, Namespace, Resource, and Time fields. In a similar vein, it should be possible to replace any field with a set of values in order to either match multiple records (GET cases) or generate multiple records (PUT cases).

It should be noted that the protocol may also be encrypted and/or compressed, if required or desired.

Exemplary embodiments include a user interface paradigm configured to support the diversity that may be associated with a general network resource comprehension system. Exemplary embodiments divide the user display into context bars and subject views. Context bars may be progressively layered on top of each other as the user's focus becomes more specific, as depicted in FIG. 7. Various constructs and renderings may be nested to solicit input and display output relevant to the given context within the subject views.

In an exemplary embodiment, the platform provides a default having a set of context bars and subject views that can be used in a generic fashion. However, the application developer may want to customize these defaults by removing, extending, or overriding interface features, depending on the use-case and audience.

In an exemplary embodiment, context bars may be cohesive, rectangular structures that contain information and controls for a given layer of system context. Bars may be horizontal or vertical in orientation. They may be layered progressively, from top to bottom, or left to right, or in some combination, from most general to most specific. An exemplary context bar is provided in FIG. 7. A system bar may contain a system label (consisting of application or system name and logo), operator label (which indicates the identity of the operator using the application), and operator controls (which control the operator's session or provide access to the operator's profile). An account bar may contain an account label (identifying the account name and status) and account controls (which manage access control lists and other account functions). A repository bar may contain a repository label (consisting of repository name and location), navigation (which provides tools for browsing and selecting repositories or modules), search (which provides a method for searching repositories or modules), and shopping cart functions (which provide e-commerce methods for purchasing or subscribing to applications or modules). A project bar may contain a project label (identifying the project), navigation (revealing links to other projects), search (providing keyword lookups), and project controls (for configuring and monitoring project services and jobs). A resource bar may contain a resource label (indicating the network resource scope of the information view), navigation (providing links to more general, more specific, or other resources), search (for wildcard matching of network resource identifiers), and resource controls (for manually modifying information about the resource). And a module bar may contain a module label (describing the topic or function), navigation (allowing selection of other functions), search (for keyword searches of functions), and module controls (for adjusting the view or module parameters). The bars provided herein are exemplary only and any user interface display system may be used.

In an exemplary embodiment, subject views accept input or commands from the user, display output or status to the user, or some combination of the two. The platform may provide a set of top-level constructs for handling these possibilities. For example, subject views may include expanded navigation and selection for instances that may need more space or flexibility than a context bar provides; search results from various context bar searches, including repositories, projects, resources, and modules; user input that may be textual, graphical, or structured as forms of such inputs; system feedback from the various services, jobs, and system functions that indicate status, progress, or other metrics; static data views that may display data in a fixed report presentation; and interactive data views that may display data but also provide mechanisms for selections or transformation in a dynamic fashion.

Exemplary embodiments of the system may include a Default Application. The Default Application may be the baseline application included with the platform that provides raw, low-level access to all the inputs, data, and processes within a project. It may be used by developers and administrators for testing, troubleshooting, and customer support. It may also provide a starting point for application developers to begin building their own customized applications for the platform, by cloning and then extending or replacing modules, UI components, and other parameters.

“Network resource analysis and augmentation” is a synthetic grouping of all the activities related to exploring, mining, assessing, and improving services offered on the Internet as well as within private networks. This may include crawling, scanning, querying, or scraping various targets to evaluate or enhance the performance, security, efficiency, quality, and overall competitiveness of an Internet offering. Analysis may target internal assets, selected external sources, or the Internet as a whole. It may also entail the collection and integration of data from back-channel sources, and the automated deployment of fixes or live reconfiguration. These activities are traditionally performed using separate, unrelated software programs and technologies, or manual, haphazard methods, if they are done at all. Exemplary embodiments described herein may define and implement a means of performing these tasks in a simple, unified manner through the use of applications, components, and modifications delivered and integrated within the platform.

As a “software platform,” exemplary embodiments described herein offer a comprehensive architecture, a collection of libraries, tools, and templates, and an array of extension points upon which to build and offer products with varying scope, foci, capabilities, and audiences. The software platform may be “distributed” since its functionality may be split between several large-grained systems controlled by numerous, distinct entities, and each large-grained system is, in turn, composed of cooperating machines.

Further, by focusing on the quality and value of Internet resources as a whole, exemplary embodiments may include methods for obtaining information that go beyond crawling and scanning. Server logs and agents, web analytics, and network traffic sensors can provide demand-side information about the usage of internally controlled resources to supplement the simulated data gathered from crawls. Interactive client-side tools can allow a user to enrich the resource knowledge base with important details not automatically available.

This approach may enable an organization not only to replace and integrate previously disconnected services, but also create new solutions previously unimagined, based on the resource-centric paradigm. The resource centric view permits data to be keyed to a particular resource scope allowing quick and easy cross-referencing.

Although embodiments of this invention have been fully described with reference to the accompanying drawings and appendixes, it is to be noted that various changes and modifications will become apparent to those skilled in the art. Such changes and modifications are to be understood as being included within the scope of embodiments of this invention as defined by the appended claims.

The term “comprising” is intended to not limit the scope of the claims and simply means including, but can include other features as well. Therefore, comprising does not mean consisting only of. The reference to any references, state of the art, tools, platforms, techniques, theories, or other description outside of the instant invention described herein should not be taken as an indication that it is prior art or forms part of the common general knowledge.

1. A Platform for Multi-Function Network Resource Analysis comprising:
a plurality of modules;
a databased configured to store subject data including raw or processed data concerning the network resource being explored and analyzed;
a first subset of the plurality of modules are configured to write data to the database indexed by a database index and the database index identifies and distinguishes different network resources from which the written data originated;
a second subset of the plurality of modules are configured to match different patterns against the database and relate data from different modules for use by other modules; and
a template of modules, wherein the template of modules identifies different combinations of the plurality of modules and each of the different combinations of the plurality of modules performs a different network resource analysis.

2. The platform of claim 1, wherein the database index comprises a module owner and network resource location and state.

3. The platform of claim 1, wherein the database index comprises a network resource identifier such that all written subject data is keyed to a particular resource.

4. The platform of claim 1, wherein the database index comprises multiple keys, wherein the platform is configured to search on each key by an exact or partial match.

5. The platform of claim 4, wherein the multiple keys comprise a resource identifier including a plurality of different resource scopes to permit variable cross-reference and correlation between modules of different levels of resource analysis.

6. The platform of claim 5, wherein the multiple keys of the plurality of different resource scopes include domain name, host address, and server.

7. The platform of claim 1, wherein the plurality of modules are configured to retrieve data about network resources and distill the retrieved data to a set of records with common fields such that the platform can analyze any resource including a website, network, server, document object, and other element available to the platform through a network.

8. The platform of claim 7, wherein the plurality of modules use a Common Messaging Protocol that enables cross-module integration.

9. The platform of claim 1, further comprising a user display system, wherein the user display system is configured to divide a user display into context bars and subject views, wherein context bars are progressively layered on top of each other and subject views nest various constructs and renderings to solicit input and display output relevant to a given context.

10. The platform of claim 9, wherein the context bars define cohesive, rectangular structures that contain information and controls for a given layer of system context.

11. A platform for Multi-Function Network Resource Analysis comprising:
a plurality of modules, wherein a module is a software unit that implement certain processing, delegation, or communication functions, wherein different subsets, arrangements, and configurations of the plurality of modules define a plurality of services or a plurality of jobs, wherein a service is a software process that waits for external initiation from an initiator and performs some function for the initiator and a job is a transient process that is started by a scheduler or triggered by an event and performs a designated function;
a databased configured to store subject data including raw or processed data concerning the network resource being explored and analyzed by a combination of the plurality of modules;
a database index;
a first subset of the plurality of modules are configured to write data to the database indexed by the database index and the database index identifies and distinguishes different network resources from which the written data originated; and
a second subset of the plurality of modules are configured to match different patterns against the database and relate data from different modules for use by other modules.

12. The platform of claim 11, wherein each service of the plurality of services and each job of the plurality of jobs specifies a set of required modules and a service instance and job instance specifies a mapping of module implementations, wherein the platform further comprises a plurality of applications defining an arrangement and configuration of a set of services and a set of jobs in a predefined way such that each application of the plurality of applications realize specific and different network resource comprehension use cases by combining different combinations of the plurality of modules.

13. The platform of claim 12, wherein an application of the plurality of applications is configured such that a pipeline of services is dynamically constructed to handle requests and return responses to realize a specific network resource comprehension use case.

14. The platform of claim 13, wherein the database index comprises a network resource identifier including a set of optional scope parameters.

15. A method of providing a distributed software platform for the development, delivery, and operation of different applications that perform different network resource analysis and augmentation, comprising:
providing a platform defining a plurality of modules, wherein a module is a software unit that implement certain processing, delegation, or communication functions, each module using a common messaging protocol
providing a database configured to store subject data including raw or processed data concerning the network resource being explored and analyzed;
retrieving data about network resources with the modules;
distilling the retrieved data to a set of records with common fields;
storing the set of records with common fields to the database indexed by the database index where the database index identifies and distinguishes different network resources from which the stored record originated;
analyzing a resource by searching the database based on multiple keys including a resource identifier having a plurality of different resource scopes to permit variable cross-reference and correlation between modules such that the platform can analyze any resource including a web site, network, server, document object, and other element available on a network.

16. The method of claim 15, further comprising providing different subsets of the plurality of modules to define a plurality of services or a plurality of jobs, wherein a service is a software process that waits for external initiation from an initiator and performs some function for the initiator and a job is a transient process that is started by a scheduler or triggered by an event and performs a designated function.

17. The method of claim 15, further comprising providing a set of downloadable templates, libraries, tools, and server processes configured to be installed to a set of machines and operated by a service provider.

18. The method of claim 17, further comprising linking the set of machines to one or more exchanges and deploying applications comprising a combination of the plurality of services and a combination of the plurality of jobs.

19. The method of claim 18, wherein the plurality of jobs and plurality of services define well defined categories and each of the plurality of jobs and each of the plurality of services is defined within only one category.

20. The method of claim 19, the well defined categories include network services, project services, project jobs and data services.

21. The method of claim 20, wherein the project services and project jobs define a plurality of subcategories including client services, proxy services, internal services, external jobs, and internal jobs, the client services handle incoming requests concerning the network resource that is in an external protocol suitable for remote communication concerning the network resource and the client services are configured to convert the incoming request from the external protocol to a common messaging protocol, the proxy services handle outgoing requests and responses concerning the network resource and the proxy services are configured to convert the outgoing request from the common messaging protocol to the external protocol, the internal services filter, transform, and distribute data between the plurality of jobs and plurality of services, the external jobs are configured for acquisition and publication of information about the network resource, and the internal jobs perform conversions and mergers of data stored in different formats by data services.

22. The method of claim 19, wherein the plurality of services includes inbound connection services configured to intercept incoming connections and requests and forward the incoming connections and requests to an appropriate client service and outbound connection services used to access network resources on a network.

23. The method of claim 22, wherein the plurality of services includes data services for reading, writing, and exchanging data between modules or the database, the data services use a common messaging protocol for data storage and retrieval.

24. The method of claim 23, further comprising downloading a subset of the plurality of services and the plurality of jobs and a subset of the plurality of modules that are mapped to the subset of the plurality of services and the plurality of jobs and configuring the subset of the plurality of services and the plurality of jobs into a first application to perform a first specific analysis of a network resource.

25. The method of claim 24, further comprising downloading a second subset of the plurality of services and the plurality of jobs and a second subset of the plurality of modules that are mapped to the second subset of the plurality of services and the plurality of jobs and configuring the second subset of the plurality of services and the plurality of jobs into a second application to perform a second specific analysis of a network resource.

26. The method of claim 25, wherein the common messaging protocol comprises a plurality of fields including operation, project, namespace, resource, time, property, value, and combinations thereof.

27. The method of claim 26, wherein the common messaging protocol comprises at least the resource field to identify a specific network resource and a namespace field to identify a topic, which are used as lookup keys for the database.
